(19) United States
(12) Patent Application Publication
(10) Pub. No.: US 2016/0216157 A1
(43) Pub. Date: Jul. 28, 2016

(54) OPTICAL MEASUREMENT OF A TEMPERATURE OF AN OBJECT, AND ASSOCIATED MAPPING

(71) Applicants: CENTRE NATIONAL DE LA RECHERCHE SCIENTIFIQUE - CNRS -, Paris Cedex 16 (FR); ECOLE NATIONALE SUPERIEURE D'ARTS ET METIERS (ENSAM), Paris (FR)

(72) Inventors: Christophe PRADERE, Talence (FR); Jean-Pascal CAUMES, Bordeaux (FR); Sabri BEN KHEMIS, Hendaye (FR)

(21) Appl. No.: 14/653,288

(22) PCT Filed: Dec. 18, 2013
(86) PCT No.: PCT/FR2013/053151

§ 371 Date: Jun. 18, 2015

(30) Foreign Application Priority Data
Dec. 21, 2012 (FR) 12 62571

(51) Int. Cl. G01J 5/02; G01J 5/08; G01J 5/10

(52) U.S. Cl. CPC G01J 5/0255; G01J 5/10; G01J 5/0896

(57) ABSTRACT

A method for the optical measurement of a variation in temperature of an object (O) includes: an emission step (S1) consisting of emitting, in the direction of the object (O), a first incident electromagnetic wave (W1_inc) of the terahertz type, and a measurement step (S2) including the measurement (S2_3), by a sensor sensitive to terahertz radiation (20), of a variation in amplitude of the electromagnetic radiation of a second electromagnetic wave (W2_ref, W2_tra) in order to determine the variation in temperature of the object (O).

### TECHNICAL FIELD

The subject matter of the present invention relates to the field of non-invasive temperature measurements.

More precisely, the subject matter of the present invention relates to the optical measurement of variations in temperature of an object.

One of the objectives of the present invention is to allow such a measurement using optical methods of the photoreflectivity or phototransmissivity type.

Another object of the present invention is to allow the construction of two-dimensional mapping and/or three-dimensional tomography of the temperature field variations of such an object.

The present invention is particularly advantageous for allowing the determination of variations in temperature of an object positioned inside an enclosure such as for example an enclosure consisting of a material having optical transparency (or semitransparency) properties at the wavelength of an incident wave beam.

The present invention thus finds numerous advantageous applications such as for example, in the detection of the start of a fire for sensitive industrial infrastructures such as for example nuclear power stations, in the maintenance of heating elements, for example in the aeronautical or automobile field, or in the detection of persons, for example for applications in the security field.

Naturally other advantageous industrial applications can be envisaged in the context of the present invention.

### PRIOR ART

Temperature fields of a volume (object) in an enclosure are generally measured in accordance with two approaches.

The first approach, which is invasive and punctiform, consists of positioning a temperature sensor such as a thermocouple inside the object itself.

The second approach uses an infrared thermography technology that remotely measures the temperature fields on the surface of the object. In order then to be able to make volume measurements, it is necessary to couple the measurements made with thermal processing methods based on inverse calculation. Such calculations, which are complex, make it possible to estimate the source of heat and/or the temperature field inside the volume.

These two approaches do however have many drawbacks both in terms of complexity of calculation and cost and in terms of precision. This is because the thermal diffusion in the volume itself gives rise to a not insignificant loss of spatial information. Likewise, these measurements require long detection time on the surface for insulating materials.

The document U.S. Pat. No. 7,922,659 describes a method and system for identifying the presence of a living body. This document relates particularly to a measurement using frequency waves having a wavelength of between 30 GHz and 30 THz. In this document, mention is made of a determination of the temperature, of the absorption of a wave, of reflectivity and/or of impedance. On the other hand, nowhere is the determination of a temperature variation described. Moreover, this document neither describes nor mentions the possibility of establishing tomography representing the temperature of an object in terms of volume, nor the measurement of these variations in temperature through the materials.

The prior art does not offer any simple and effective solution for obtaining in real time and non-invasively and non-destructively a precise estimation of the variations in temperature of an object, and in particular of an object positioned in an enclosure.

### SUBJECT MATTER AND SUMMARY OF THE PRESENT INVENTION

The present invention aims to improve the situation described above.

Thus the present invention aims to make it possible to make non-invasive measurements, in real time, in order to be able to characterise the transient variations in temperatures of one or more objects, in particular objects positioned in an enclosure such as for example n enclosure that is transparent (or semitransparent) at a frequency and formed in a (thermally) insulating material.

The present invention also relates to the use of these measurements by enabling mapping or tomography of these variations with a spatial resolution that is improved compared with the prior art.

Thus the subject matter of the present invention relates to a method for the optical measurement of the temperature of an object.

According to the present invention, the method comprises an emission step that consists in particular of emitting a first incident electromagnetic wave in the direction of the object.

Advantageously, this first wave has a given emission frequency that is of the terahertz type. Preferably, this given emission frequency is between around 100 GHz and 30 THz; such an emission frequency corresponds to an electromagnetic wave the wavelength of which is between approximately 20 μm and 3 mm.

In an advantageous embodiment, the object is positioned in an enclosure.

It will be understood that this enclosure is transparent or semi-transparent to such an emission frequency. In other words, the enclosure allows a portion of the first electrode magnetic wave to pass at least partially. The enclosure is therefore formed from a material that is transparent or semi-transparent to the incident wave.

Optionally, the chamber is formed in a thermally insulating material.

Advantageously, the measurement method comprises a measurement step that comprises in particular the measurement, by means of a sensor, of an amplitude of the electromagnetic radiation of a second electromagnetic wave.

Preferably, the sensor is sensitive to terahertz radiation.

The measurement thus makes it possible to determine one or more variations in temperature of the object.

This second wave may be a reflected wave or a wave transmitted by the object. It will be understood here that, according to the optical properties of the object, the second wave is a reflected wave or a transmitted wave.

Thus, by virtue of the succession of these technical steps, features of the present invention, it is possible to quantify the variations in temperature of an object such as for example an object positioned inside an enclosure that is transparent (or semitransparent) to the radiation of an electromagnetic wave.

This is made possible by using conjointly:
firstly the terahertz radiation of an incident wave; terahertz radiation has in particular the property of passing through opaque and insulating (or not) media in order to measure the optical, mechanical and/or physical characteristics thereof, and
secondly, the sensitivity of terahertz radiation to the temperature of a material, in particular to variations in temperature of a material.

The applicant submits that, in the document U.S. Pat. No. 7,922,659 cited above, it is impossible to separate a variation in temperature from a simple variation in the absorption of a wave, in the reflectivity and/or in the impedance; this is because, in this document, the responses to incident wave emission are coupled.

In this document, nowhere is mention made of a measurement of a reference wave in order to subsequently determine a relative variation with the temperature of the optical reflectivity (or transmissivity) coefficient.

In an advantageous embodiment, a variation in amplitude of the electromagnetic radiation is measured during the measurement step, in order to determine a variation in temperature.

Advantageously, the measurement step according to the present invention comprises a modulation of the first and/or second wave at a given modulation frequency, this modulation frequency preferably being between around a few hertz and a few megahertz.

This modulation, which occurs on the first wave before the radiation of the object, or on the second wave after reflection or transmission, improves the precision of the measurement made.

Advantageously, the measurement step according to the present invention comprises a synchronous detection of the second wave. This synchronous detection thus increases the precision of the measurement by eliminating all or some of the noise (minimisation of the signal to noise ratio), by amplitude amplification and phase shifting.

In an advantageous embodiment, during the measurement step, the sensor is moved in a matrix fashion with respect to the object, or vice versa.

This relative movement of the sensor with respect to the object makes it possible to acquire measurements in order then to construct a two-dimensional mapping of the temperature variation field of the object.

In another embodiment, which can optionally be combined with the above mode, the sensor is moved, during the measurement step, on the same plane at different angular positions around the object.

This relative movement of the sensor with respect to the object makes it possible to acquire measurements in order then to allow three-dimensional tomography of the temperature variation field of the object.

Advantageously, the measurement method comprises a step of constructing a mapping of the temperature variation field of an object from variations in temperature measured during the measurement step.

This construction step therefore aims to use the results of the optical measurement described above.

In an advantageous embodiment, during the measurement step, the sensor is moved on the same plane at different angular positions around the object. In this variant, the construction step uses Radon transforms for a construction of the three-dimensional tomography.

Correspondingly, the subject matter according to the present invention also concerns a system for the optical measurement of the temperature of an object that is configured so as to implement the steps of the optical measurement method as described above.

More precisely, the optical measurement method advantageously comprises:
an emission module that is configured so as to emit, in the direction of the object, a first incident electromagnetic wave having a given emission frequency of the terahertz type (preferably between around 100 GHz and 30 THz), and
a sensor configured so as to measure an amplitude of the electromagnetic radiation of a second electromagnetic wave in order to determine a variation in temperature of said object, this said second wave being a wave reflected or transmitted by said object according to its optical properties.

Preferably, the sensor used is sensitive to terahertz radiation.

In a first variant, the sensor is configured so as to allow a modulation of the reflected or transmitted wave at a given frequency, this frequency preferably being between around a few hertz and a few megahertz.

In a second variant, which can optionally be combined with the first variant above, the emission module is configured so as to allow a modulation of the first incident wave at a given frequency, this frequency preferably being between around a few hertz and a few megahertz.

Advantageously, the sensor is configured so as to allow a synchronous detection of the second wave.

In an advantageous embodiment, the optical measurement step system according to the present invention comprises a first movement means configured so as to move the sensor in a matrix manner with respect to said object, or vice versa.

In another embodiment, which may be combined with the first embodiment above, the optical measurement system according to the present invention comprises a second movement means that is configured so as to move the sensor over the same plane at various angular positions around said object.

Advantageously, the optical measurement system according to the present invention comprises data processing means configured so as to construct a two-dimensional mapping or a three-dimensional tomography of the temperature variation field of an object from the variations in temperature measured.

According to an advantageous embodiment, the data processing means use the Radon transforms for the construction of a three-dimensional tomography.

Thus the subject matter of the present invention, through its various functional and structural aspects, allows a precise optical measurement of the temperature variation fields of an object. The present invention also allows a use of these measurements by improving the spatial precision of the mapping of these transient fields and assisting computation of this mapping.

### BRIEF DESCRIPTION OF THE ACCOMPANYING FIGURES

Other features and advantages of the present invention will emerge from the following description, with reference to the accompanying FIGS. 1 to 5, which illustrate an example embodiment thereof devoid of any limitative character, and in which:

FIG. 1 depicts a flow diagram representing the various steps of the measurement method according to an advantageous example embodiment;

FIG. 2 depicts schematically a measurement system according to an advantageous example embodiment;

FIGS. 3a and 3b relate to two graphs illustrating the temperature measurements on an object carried out respectively with a measurement system according to FIG. 2 and a conventional thermocouple;

FIGS. 4a and 4b depict respectively the change over time in the temperature of an object according to various positions and an image representing the temperature variation fields obtained at a given instant; and

FIG. 5 depicts schematically an image representing the temperature field of an object in a perpendicular plane.

### DETAILED DESCRIPTION OF AN ADVANTAGEOUS EMBODIMENT

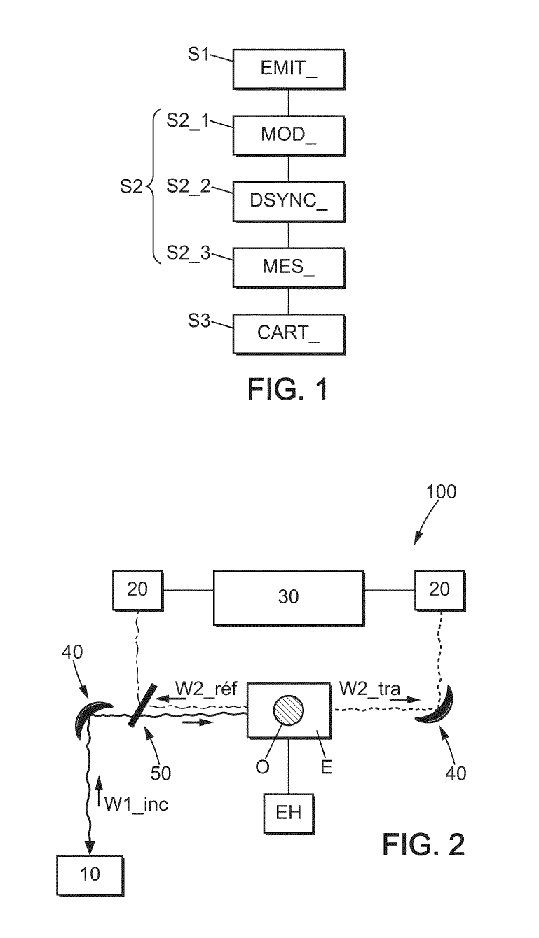

An optical measurement method according to an example embodiment and the associated system 100 will now be described hereinafter with reference conjointly to FIGS. 1 to 5.

Allowing a non-invasive measurement of the temperature of an object O positioned inside an enclosure E for constructing a mapping or a tomography C of the temperature variation fields of said object O is one of the objectives of the present invention.

To this end, in the example described here and as illustrated in FIG. 2, an object O is disposed in an enclosure E consisting of a thermally insulating material.

In the example described here, the optical measurement system 100 comprises an emission module 10, for example of the Gunn diode type (P=20 mW and λ=60 mm), which emits, during an emission step S1, a first incident electromagnetic wave W1_inc. The emission module 10 is configured here so that this first wave W1_inc has an emission frequency between around 100 GHz and 30 THz. A frequency of around one terahertz is therefore spoken of here.

In the example described here, the system 100 comprises a directional element 40 such as a parabolic mirror 40 that is arranged with one or more lenses (not shown here). This arrangement makes it possible to orient the first incident electromagnetic wave W1_inc in the direction of the object O so that this wave W1_inc “illuminates” said object O.

Preferably, in the example described here, the parabolic mirror used is a parabolic mirror made from gold with a focal distance of 150 mm.

Moreover, the lenses used are planoconvex lenses made from Teflon® that has a focal distance of 60 mm. A person skilled in the art will understand here that the enclosure E in which the object O is positioned is an enclosure that is semitransparent or even transparent to the waves having such an emission frequency.

As illustrated in FIG. 2, the first wave W1_inc therefore illuminates the object O.

Next, two types of optical configuration can be envisaged in the context of the present invention: a measurement in reflection or a measurement in transmission.

This is because the intrinsic optical properties of the object O mean that this first wave W1_inc is reflected or transmitted in accordance with a second electromagnetic wave denoted here W2_ref (for the reflected waves) or W2_tra (for the transmitted waves).

According to the optical properties of the object, the measurements will therefore be sensitive in transmission or in reflection.

The two configurations are illustrated here in FIG. 2.

As illustrated in this FIG. 2, in the example described here, the second wave W2_ref is returned to a sensor 20 by means of a splitter element 50 of the “beam splitter” type, in order to separate the second wave W2_ref from the first wave W1_inc, and to reorient this second wave W2_ref to the sensor 20.

In the same way, in the case where the wave is transmitted, the second wave W2_tra is reoriented by means of a directional element 40 such as a parabolic mirror 40.

This second wave W2_ref or W2_tra is therefore captured by a sensor 20 of the system 100, this sensor 20 being sensitive to terahertz radiation. In the example described here, this sensor 20 is a terahertz monodetector based on the thermoconversion principle.

In the example described here, various treatments are provided for this wave W2_ref or W2_tra by the sensor 20; these treatments are aimed mainly at improving the spatial precision of the information that will be extracted from these waves.

Thus, in the example described here, this second wave W2_ref or W2_tra is modulated during a modulation step S2_1, by a mechanical chopper, at a modulation frequency of between around a few hertz and a few megahertz. This modulation makes it possible to dispense with thermal losses and to obtain a suitable signal to noise ratio.

Next, this second wave W2_ref or W2_tra undergoes a synchronous detection S2_2. This synchronous detection makes it possible to obtain the variations in amplitude and phase difference with respect to the reference that is given by the mechanical chopper.

These various steps are implemented by the sensor 20, which is specially adapted for this purpose (the processing means of the sensor not being shown here).

As mentioned above, the sensor 20 is sensitive to terahertz radiation. Thus it is possible, by measurement step a variation in amplitude of the electromagnetic radiation of the second electromagnetic wave W2_ref or W2_tra, to determine a variation in temperature of the object O.

This results from the properties of terahertz radiation, which is sensitive to variations in temperature of materials.

More particularly, measurement step the variation in amplitude ΔA (=A−A₀) relating to the variation in the reflectivity coefficient ΔR (=R−R₀) makes it possible to obtain the variation in temperature (=T−T₀) according to the following formula:

$$\frac{Δ A}{{A}_{0}} = \frac{Δ R}{{R}_{0}} = k ( T - {T}_{0} )$$

in which:
k corresponds to a coefficient of thermoreflectivity or thermotransmissivity (in K⁻¹),
A0 is the amplitude of the second electromagnetic wave W2_ref or W2_tra at the initial temperature T0,
A is the amplitude of the terahertz electromagnetic wave when the temperature varies, that is to say the amplitude of the second electromagnetic wave W2_ref or W2_tra at the initial temperature T,
R0 is the coefficient of reflectivity of the second electromagnetic wave W2_ref or W2_tra at the initial temperature T0,
R is the coefficient of reflectivity of the terahertz electromagnetic wave when the temperature varies, that is to say the coefficient of reflectivity of the second electromagnetic wave W2_ref or W2_tra at the initial temperature T,
T is the temperature (in K),
T0 is the initial temperature (in K).

In the example described here, the amplitude of an electromagnetic wave corresponds to an intensity.

The major difficulty in the visible range in particular is sensitivity.

This is because the coefficient K is around 10⁻⁵ K⁻¹. Thus, for a temperature variation of 1K, the relative variation in intensity of the incident wave is 0.001% whereas, in the frequency range of one terahertz, this variation is 0.1%.

Thus, according to the invention, the modulated incident wave is emitted on the material to be measured and the reflected (or transmitted) part of the wave is recorded by means of a sensor.

This assembly is connected to a synchronous detection device that measures the amplitude between these two waves (the incident wave and the measured wave).

This measurement obtains a reference signal that reveals the optical properties (absorption, transmission or reflection) of the material at the reference temperature T0.

Next, on an experimental level, by means of external heating (Joule effect, laser, etc.) a variation in temperature of the material is achieved, which will be measured as a function of time in order to simulate a variation in temperature.

Afterwards, the above formula is applied using data measured for obtaining a variation proportional to the variation in temperature.

In order to obtain the absolute temperature, an additional step of calibration is necessary, which aims to identify the exact value of the k, which depends on the wavelength of the incident wave and the optical properties of the material.

On an experimental level, measurements according to the method described above were carried out on a portion of a silicon wafer (object O) positioned in an insulating enclosure E.

In the context of the experiment, this portion O is heated at its ends by a heating element EH of the Peltier element type. This creates a variation in temperature that propagates along the silicon wafer. The experimental protocol aims here to observe this temperature variation using the measurement method described above.

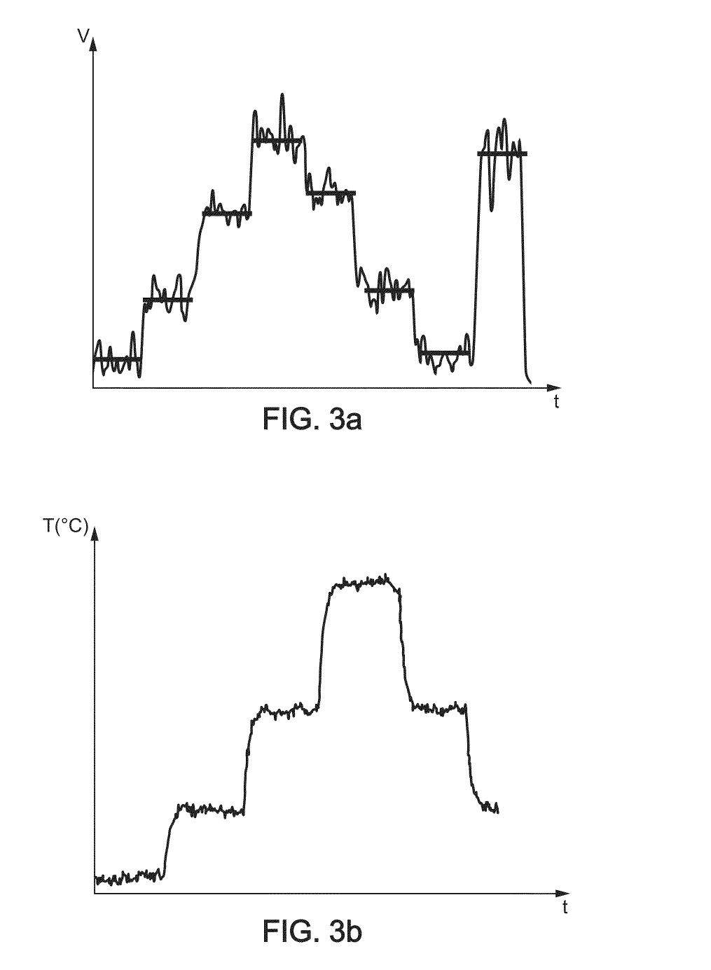

The results of these measurements are shown in FIG. 3a.

In this experiment, the other portion of the wafer is not positioned in the enclosure E and is in open air. Similar measurements were carried out on this other portion with an infrared camera and a thermocouple.

The results of these measurements are shown in FIG. 3b.

The measurements obtained on each portion are identical (there exists a linear relationship between the measurements). This experiment validates the measurement protocol and reveals the correlation between the measurement of the variations in amplitude of a terahertz wave coming from a heated object and the variations in temperature of this object.

Allowing use of the temperature variation measurements on an object O in order to construct a mapping or a tomography of the temperature variation fields of said object O is also one of the objectives of the present invention.

Thus the system 100 comprises a first movement means (not shown here) that make it possible to move the sensor 20 in a matrix manner with respect to said object O in order to make it possible to obtain several “surface” measurements of the temperatures of the object O.

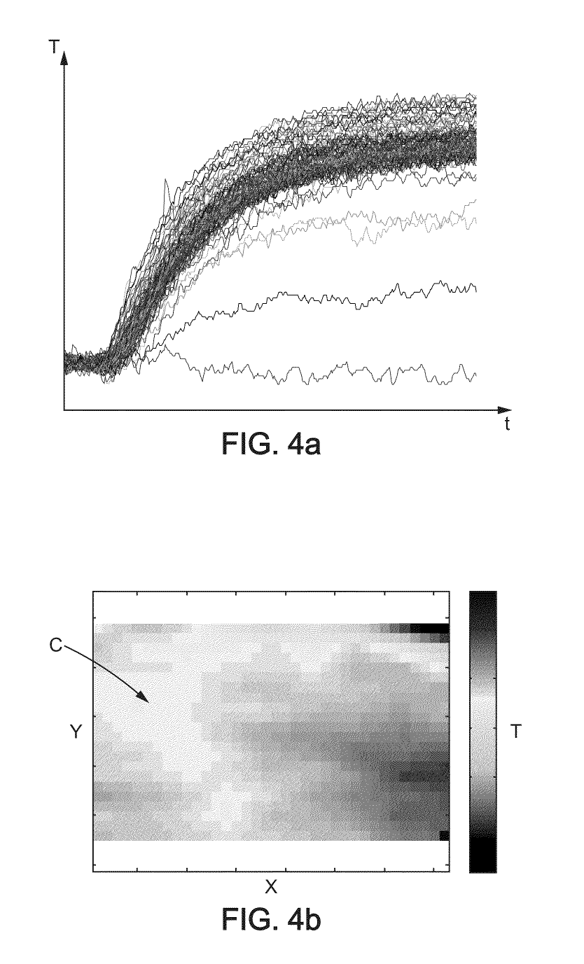

Such measurements are shown for example in FIG. 4a, which illustrates the change over time in the temperature of an object O such as a silicon wafer heated at its ends by a heating element EH, such measurements being performed for various matrix positions of the object O.

By means of such measurements, it is thus possible to obtain an image C such as the 2D mapping shown in FIG. 4b.

It is also possible to carry out 3D tomography showing in particular the temperature variation fields inside an object (that is to say those relating to a transverse cutting plane of the object).

The optical measurement system 100 comprises for this purpose a second movement means (not shown here).

This second movement means makes it possible to move the sensor 20 on the same plane at various angular positions about the object O.

It is possible to provide for the use of a tomograph to afford a 3D measurement of the variations in optical properties of the system.

The sensor 20 can therefore recover various temperature variation measurements around the object O. To determine the temperature variation field for each transverse section of the object O, the system 100 comprises data processing means such as a computer using, during a reconstruction step S3, Radon transforms.

FIG. 4 shows an image C resulting from such computer processing for an advantageous example embodiment.

It is next possible to reconstruct a complete 3D tomograph of the temperature variation field of the object O by conventional image processing methods for 3D reconstructions.

More particularly, from the various 2D mappings obtained for thickness, it is possible to calculate the relative variation in temperature:

$$\frac{T - {T}_{0}}{{T}_{0}} .$$

Next a Radon transform is applied to the resultant.

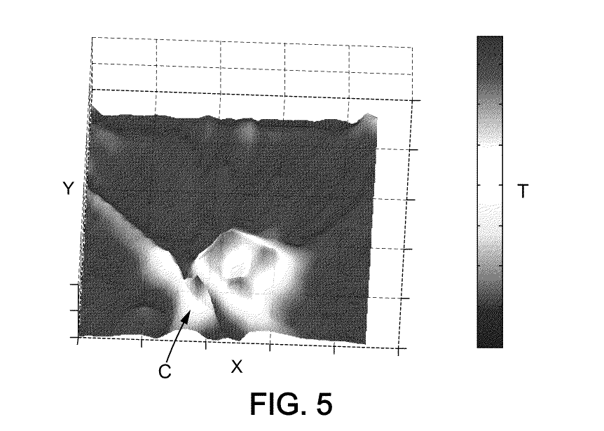

By means of this processing, an image such as the one shown in FIG. 5, which shows the temperature field measured, is obtained after interpolation.

This type of protocol makes it possible to carry out volume temperature measurements.

The present invention therefore makes it possible to obtain, non-invasively and non-destructively, the measurements of temperature variation fields of an object such as for example an object placed in a semitransparent enclosure at a given emission frequency.

The present invention next makes it possible to use these measurements by constructing a precise mapping or tomography of the temperature variation fields of this object.

The present invention thus makes it possible to develop a thermal tomography method for measurement step transient 3D temperature fields in the volume of materials or objects.

More particularly, the present invention makes it possible to couple THz photoreflectivitiy and measurement of a temperature field by IR thermography.

Thus the present invention consists of illuminating an object, which undergoes a temperature variation, by a modulated incident beam of THz waves and measurement step the variation in amplitude of this same transmitted or reflected beam by means of a thermal sensor associated with a thermoconversion system.

The technology deployed here in the context of the present invention makes it possible to exploit the “traversing” character of THz waves vis-à-vis numerous materials opaque to other wavelengths, such as visible or infrared. Thus, by means of the present invention, it becomes in particular possible to image a temperature field of an object situated behind materials such as concrete, wood or plastics material.

Thus the present invention finds numerous advantageous applications for measurement step and controlling temperature variations, in particular for controlling and maintaining the temperature stability of sensitive industrial infrastructures.

It should be noted that this detailed description relates to a particular example embodiment of the present invention but that under no circumstances does this description have any limitative character with respect to the subject matter of the invention; quite the contrary, its objective is to remove any imprecision or faulty interpretation of the following claims.

1-10. (canceled)

11. A Method for the optical measurement of a temperature of an object positioned inside an enclosure, comprising the following steps:
an emission step consisting of emitting, in the direction of said object, a first incident electromagnetic wave having a given emission frequency, and
a measurement step comprising the measurement, by means of a sensor, of a variation in amplitude of the electromagnetic radiation of a second electromagnetic wave in order to determine a variation in temperature of said object, said second wave being a wave reflected or transmitted by said object according to its optical properties,
a measurement method in which said given emission frequency is of the terahertz type, said sensor being sensitive to terahertz radiation, and said enclosure is transparent or semitransparent to said given emission frequency.

12. The measurement method according to claim 11, wherein the measurement step comprises a modulation of the first or second wave at a given modulation frequency, said given modulation frequency preferably being between around a few hertz and a few megahertz.

13. The measurement method according to claim 11, wherein the measurement step comprises a synchronous detection of the second wave.

14. The measurement method according to claim 11, wherein said given emission frequency is between around 100 GHz and 30 THz.

15. The measurement method according to claim 11, wherein, during the measurement step, the sensor is moved in a matrix fashion with respect to the object, or vice versa.

16. The measurement method according to claim 11, wherein, during the measurement step, the sensor is moved on the same plane at various angular positions about the object.

17. The measurement method according to claim 11, further comprising a construction step consisting in particular of reconstructing a mapping or tomography of the temperature variation field of an object, from temperature variations measured during the measurement step.

18. The measurement method according to claim 17, wherein the sensor is moved during the measurement step on the same plane at various angular positions about the object, and wherein the construction step uses Radon transforms for construction of the three-dimensional tomograph.

19. A system for the optical measurement of the temperature of an object positioned inside an enclosure, comprising:
an emission module configured so as to emit, in the direction of said object, a first incident electromagnetic wave having a given emission frequency of the terahertz type, and said enclosure being transparent or semitransparent to said given emission frequency, and
a sensor configured so as to measure a variation in amplitude of the electromagnetic radiation of a second electromagnetic wave in order to determine a variation in temperature of said object, said second wave being a wave reflected or transmitted by said object according to its optical properties, and said sensor being sensitive to terahertz radiation.

20. The measurement method according to claim 12, wherein the measurement step comprises a synchronous detection of the second wave.
